(19) United States
(12) Patent Application Publication
(10) Pub. No.: US 2024/0096059 A1
(43) Pub. Date: Mar. 21, 2024

(54) METHOD FOR CLASSIFYING IMAGES AND METHOD FOR OPTICALLY EXAMINING AN OBJECT

(71) Applicant: FRESENIUS MEDICAL CARE DEUTSCHLAND GMBH, Bad Homburg (DE)

(72) Inventors: Phillip VASSEN, Schweinfurt (DE); Axel KORT, Unterhaching (DE)

(73) Assignee: FRESENIUS MEDICAL CARE DEUTSCHLAND GMBH, Bad Homburg (DE)

(21) Appl. No.: 18/039,493

(22) PCT Filed: Dec. 17, 2021
(86) PCT No.: PCT/EP2021/086565

§ 371 Date: May 31, 2023

(30) Foreign Application Priority Data
Dec. 18, 2020 (DE) 10 2020 216 289.1

(51) Int. Cl. G06V 10/764; G06T 3/00; G06T 5/00; G06T 7/00

(52) U.S. Cl. CPC G06V 10/764; G06T 3/0006; G06T 5/002; G06T 7/0008; G06T 2207/20084

(57) ABSTRACT

A method for classifying images, in which the images are classified according to good images and bad images, comprises the following steps:
capturing image data of an image, and
classifying the image as a good image (GB) or a bad image (SB, SB2),
wherein the classification is made using an artificial neural network trained by supervised learning using training data from a plurality of good images (GB) and a plurality of bad images (SB), wherein each bad image (SB) of at least a subset of the plurality of bad images (SB) of the training data corresponds to a respective good image (GB) of at least a subset of the plurality of good images (GB) of the training data, into which at least one image error (11) is inserted, and wherein the artificial neural network is trained using respective pairs of a respective good image (GB) from the subset of the plurality of good images (GB) and a respective bad image (SB) from the subset of the plurality of bad images (SB), wherein a respective bad image (SB) corresponds to the good image (GB) belonging to the same pair, into which the at least one image error (11) is inserted. The method according to the invention makes it possible, in particular, to identify small defects (defective areas from 1 pixel) on large areas.

The present invention relates to a method for classifying images and a method for optical inspection of an object, in which the method for classifying images is used.

Before delivery to a customer, products or objects, such as medical devices and/or components or objects of these products, which have been manufactured using a manufacturing process, typically undergo a quality control of a final acceptance, which may contain an optical inspection or optical final acceptance. In the case of such an optical final acceptance, depending on the condition of the object determined by the optical inspection, it is determined whether the respective inspected object is in a state in which it can be delivered to the customer, or whether the product or the component or the object needs to be reworked before delivery.

With such an optical final acceptance, it can be inspected, for example, whether the object or the final assembled device or the component of the device is correctly labeled or marked according to a specification, is configured according to customer-specific requirements, and whether the object has one or more optical defects. As part of the inspection to determine whether the object has optical defects, a surface or surfaces of the object can be inspected to determine whether these have dents, scratches or spots that may have been insufficiently removed during a final cleaning of the object. The inspection can be carried out by human inspectors using defined evaluation criteria. In this process, however, the human inspectors can overlook minor defects, which can result in fluctuations in the quality of the products or objects delivered, in particular the final assembled devices. In addition, manual control is an exhausting task for the inspectors' concentration and eyesight.

To inspect whether the object is correctly labeled or marked according to a specification and/or to inspect whether the object is configured according to customer-specific requirements, known optical inspection systems with a camera for capturing an image of the object to be inspected and a freely available open source software product, the parameters of which can be individually adapted to the respective object to be inspected, can be used. Here, for example, the parameters for the resolution and magnification of the image can be set in the camera and/or software settings, and the fixed points or features to be found by the software that are characteristic of the features of the object to be inspected can be set in the software settings.

For the inspection for optical defects, in particular for minor optical defects such as small scratches, small dents or small spots, on large-area objects or to detect these defects in corresponding images of the objects, in particular to detect small anomalies in these images, such known optical inspection systems are, however, not suitable.

In the context of machine learning, there are approaches to anomaly detection in images using deep learning, in which small-resolution images with less complex patterns are examined for details or complex medium-resolution patterns are examined for gross anomalies. Current models that are used for deep learning are particularly suitable for detecting features on medium to large pixel areas. However, none of these models is designed for the classification of the smallest anomalies in high-resolution images with complex and varied image patterns, as they occur in images of large, non-reflective and less color-intensive surfaces with small optical defects.

Furthermore, the provision of “bad images” of the object for training purposes of the artificial neural network used in deep learning, that is to say images of an object that has optical defects, is difficult because the proportion of objects without optical defects in production is considerably larger. An additional challenge is that a plurality of potential anomalies or optical defects cannot be covered by appropriate training material for training the artificial neural network used in deep learning.

It is therefore an object of the present invention to provide an improved method for classifying images and an improved method for optical inspection of an object.

This object is achieved by the features of the independent claims. Preferred embodiments of the invention are the subject matter of the dependent claims and the present description of the invention.

A method according to one embodiment, in particular a computer-implemented method, for classifying images, in which the images are classified according to good images and bad images, comprises the following steps:
capturing image data of an image, and
classifying the image as a good image or a bad image,
wherein the classification is made using an artificial neural network trained by supervised learning using training data from a plurality of good images and a plurality of bad images,
wherein each bad image of at least a subset of the plurality of bad images of the training data corresponds to a respective good image of at least a subset of the plurality of good images of the training data, into which at least one image error is inserted, and wherein the artificial neural network is trained using respective pairs of a respective good image from the subset of the plurality of good images and a respective bad image from the subset of the plurality of bad images, wherein a respective bad image corresponds to the good image belonging to the same pair, into which the at least one image error is inserted.

According to the invention, each bad image of at least a subset of the plurality of bad images of the training data corresponds to a respective good image of at least a subset of the plurality of good images of the training data, into which at least one image error is inserted. In other words, each bad image of the subset of the plurality of bad images of the training data is generated by a good image, into which the at least one image error is inserted, of the subset of the plurality of good images of the training data.

In this way, in the conventional capturing of images actually captured by means of an image capture device in order to provide the bad images as training data, potential interference variables from the environment can be reduced when the bad images are captured for the training data.

Furthermore, any number of bad images can be provided for the training data in this way. This is particularly advantageous in a case in which a small number of bad images are available, for example in a case in which the images to be classified are images of an object such as a medical device or a component thereof, and based on the images to be classified an optical final acceptance should be carried out before delivery of the object to a customer, since the proportion of optically flawless objects intended for optical final acceptance is considerably greater than the proportion of optically defective objects intended for optical final acceptance. Furthermore, the possibility of providing any number of bad images for the training data is advantageous in a case in which potential optical anomalies of the objects cannot be covered by corresponding training data or the variety of possible errors is very large.

The at least one image error is preferably selected in such a way that it corresponds to or is at least similar to an image error that is actually to be expected which occurs as a result of an optical defect of an object to be inspected in an image of the object.

In addition to the subset of the plurality of bad images, the plurality of bad images can also contain bad images which have not been generated from good images. In other words, the plurality of bad images of the training data can actually contain bad images that were created directly by camera recordings and were not generated. Here, the proportion of generated bad images or the subset of the plurality of bad images can make up the majority of the plurality of bad images of the training data, preferably over 60%, even more preferably over 70% or 80%.

Likewise, the method for classifying images, in which the images are classified according to good images and bad images, may comprise the following steps: capturing image data of an image, and classifying the image as good image or bad image, wherein the classification is made using an artificial neural network trained by supervised learning using training data from good images and bad images, wherein each bad image of the training data corresponds to a respective good image of the training data, into which at least one image error is inserted, and wherein the artificial neural network is trained using respective pairs of a respective good image and a respective bad image, wherein a respective bad image corresponds to the good image belonging to the same pair, into which the at least one image error is inserted.

In one embodiment, after the classification has taken place, the result of the classification can be output by means of an output device, for example a display device. Visualized by so-called attention heat maps, the decisive areas can be highlighted by optically superimposing a colorcoded calculation result over the original image.

The artificial neural network can be trained by a respective adaptation of parameters of the artificial neural network after a respective input of the image data of a respective pair of a respective good image and a respective bad image. This advantageously enables the artificial neural network to distinguish the typical errors of a bad image from typical features of a good image, which is hardly possible if another approach is used for the input of training data.

According to one embodiment, the at least one image error is a randomized pixel error, a line of pixel errors or an area error, and/or generated by distorting, blurring or deforming an image portion of the good image, by an affine image transformation of the good image, by augmented spots, circular, elliptical or rectangular shapes, which can also be completely or only partially colored or filled in gray levels.

The artificial neural network is preferably designed as a convolutional neural network, which has an input layer, an output layer and several hidden layers arranged in between, wherein during the training of the artificial neural network a combination of regularization in all hidden layers with a loss function is taking place.

Here, an output of the last layer of the neural network can be converted into a probability distribution by a softmax function, and the classification can be made on the basis of the probability distribution.

Here, furthermore, the artificial neural network can be trained using a self-adaptive optimization method, preferably a rectified adam method.

Due to this configuration, despite the high similarity of the good images of the subset of the plurality of good images and bad images of the subset of the plurality of bad images used for the training data, very large or small gradients, which could lead to numerical instabilities in the gradient method and thus to aborts of the optimization process or to the determination of local minima, which would make it more difficult to find a suitable parameter set for the model of the artificial neural network, can be avoided.

A method according to one embodiment, in particular a computer-implemented method, for optical inspection of an object comprises the following steps:
capturing image data of at least one image of the object,
classifying the at least one image of the object as a good image or as a bad image using a method described above for classifying images, wherein the capturing of image data of an image includes the capturing of image data of the at least one image of the object,
determining that the object is free of defects if the at least one image of the object is classified as a good image, or
determining that the object is faulty if the at least one image of the object is classified as a bad image.

The method for optical inspection of an object can be used, for example, as part of a optical final acceptance in order to inspect an object manufactured by means of a manufacturing process, for example a medical device, for optical defects of a surface of the object before delivery to a customer, and to deliver the object to the customer only if it is determined by the method that the object is free of defects, and otherwise to arrange for the object to be cleaned or for the object to be touched up.

According to one embodiment, the method further comprises the following steps:
outputting, by means of an output device, information about the fact that the object is free of defects if it is determined that the object is free of defects, or
outputting, by means of the output device, information about the fact that the object is faulty if it is determined that the object is faulty.

In a preferred embodiment, the method further comprises a step of displaying, if it is determined that the object is faulty, by means of an output device designed as a display device, the at least one image of the object and a mask which is generated based on an output of the artificial neural network, wherein the mask is superimposed on the at least one image of the object and indicates a defect of the object, which is output by the artificial neural network, and its position.

In this case, an inspector can use the information displayed by means of the mask to visually inspect the object himself in the next step and decide whether the object or the manufactured machine can be shipped, whether the object has to go through the cleaning process again or eventually whether it is postponed for further rework.

According to one embodiment, the capturing of image data of at least one image of the object comprises capturing image data of a plurality of images of the object at a plurality of different angles relative to the object, wherein
it is determined that the object is free of defects if each of the plurality of images of the object is classified as a good image, or
it is determined that the object is faulty if at least one of the plurality of images of the object is classified as a bad image.

Here, in one embodiment, capturing image data of a plurality of images of the object at a plurality of different angles relative to the object can comprise the following steps:
arranging the object on a rotatable platform,
controlling a drive device of the rotatable platform in order to rotate the rotatable platform, and
capturing, by means of an image capture device, the image data of the plurality of images of the object at the plurality of different angles relative to the object, while the rotatable platform is rotated by the drive device.

In another embodiment, capturing image data of a plurality of images of the object at a plurality of different angles relative to the object can comprise the following steps:
arranging the object on a platform,
controlling a drive device of an image capture device in order to move the image capture device around the object, and
capturing, by means of the image capture device, the image data of the plurality of images of the object at the plurality of different angles relative to the object, while the image capture device is moved around the object by the drive device.

In the latter embodiment, the image capture device is designed to be movable instead of the rotatable platform. Here, the image capture device can be moved around the object, for example via a rail system. Here, the image capture device is moved around the object by a drive device.

The artificial neural network is preferably trained using training data from a plurality of good images and a plurality of bad images, the good images each being images of at least one portion of a medical device, preferably a dialysis machine.

According to one embodiment, the at least one image error corresponds to or is at least similar to an optical defect of a surface of the object, preferably a scratch or a dent in the surface of the object or a spot on the surface of the object.

The images can also be divided into smaller portions and the portions can be calculated in parallel. Here, the same architecture of the neural network can be used, wherein the weighting of the nodes is adapted depending on the examined object portion.

Further preferred configurations of the method according to the invention emerge from the following description of the exemplary embodiments in conjunction with the drawings and their description. The same components in the exemplary embodiments are essentially identified by the same reference signs, unless otherwise described or if the context does not indicate otherwise. In the drawings:

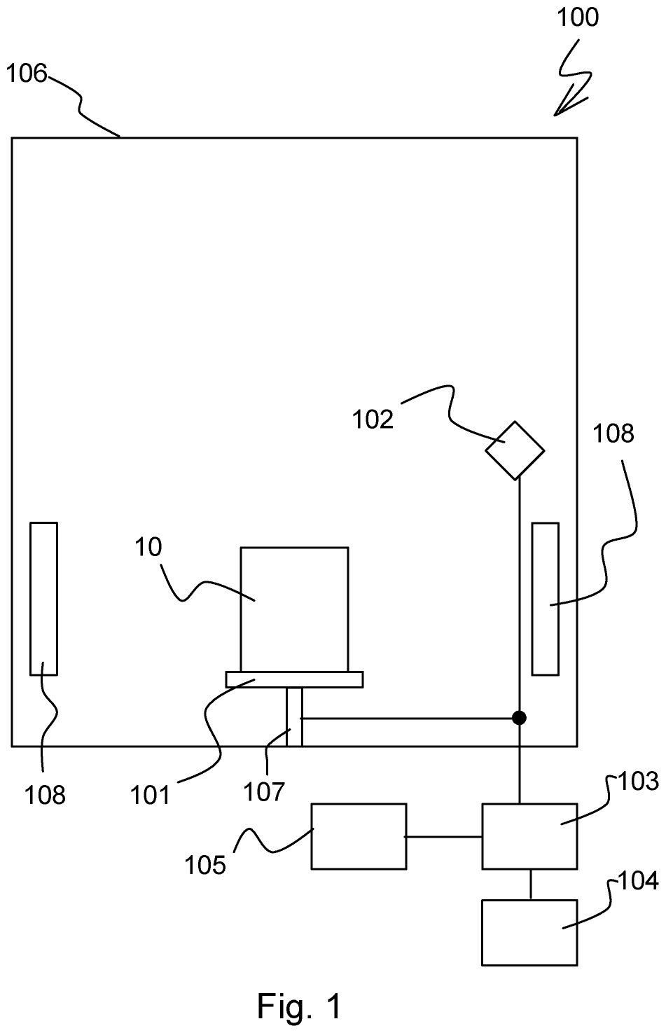

FIG. 1 schematically shows a device for classifying images and, if necessary, for optical inspection of an object according to an embodiment,

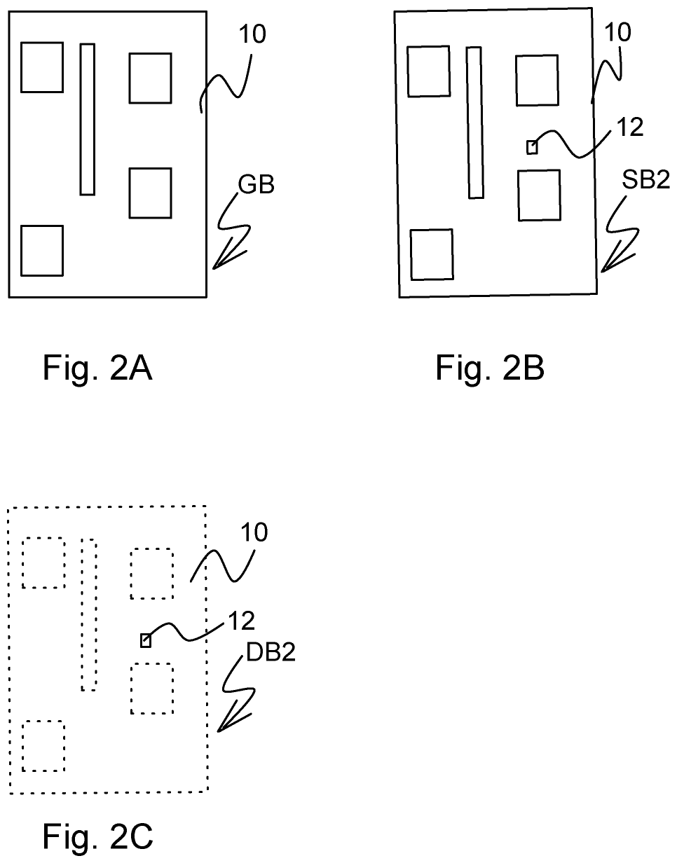

FIG. 2A-C schematically shows a good image of an object, a bad image of another object and a difference image generated from the good image and the bad image,

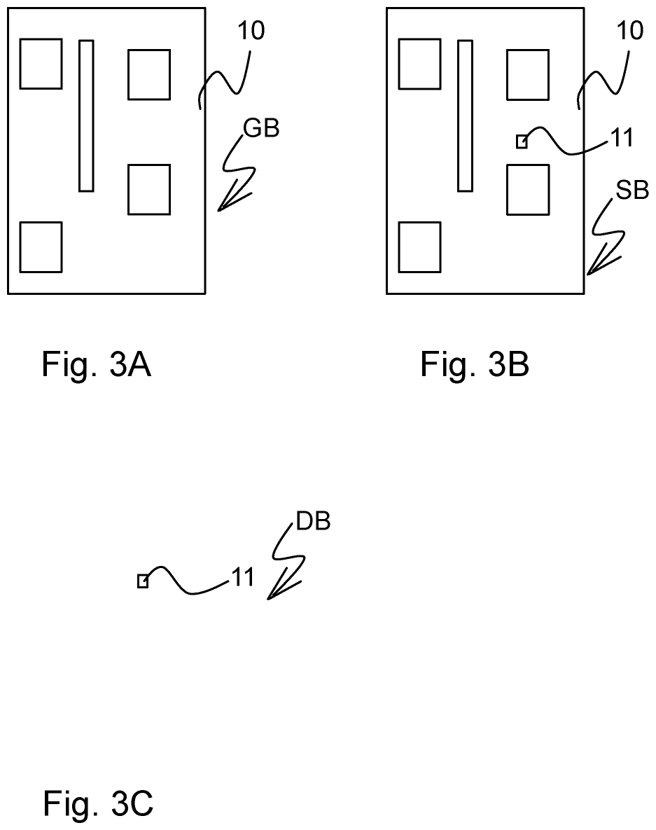

FIG. 3A-C schematically shows a good image of an object, a bad image of the object, and a difference image generated from the good image and the bad image.

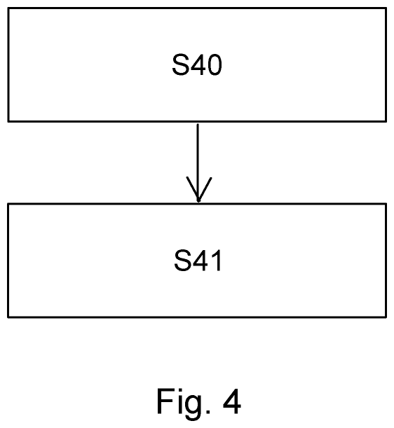

FIG. 4 shows a flow chart for illustrating a method for classifying images according to an embodiment, and

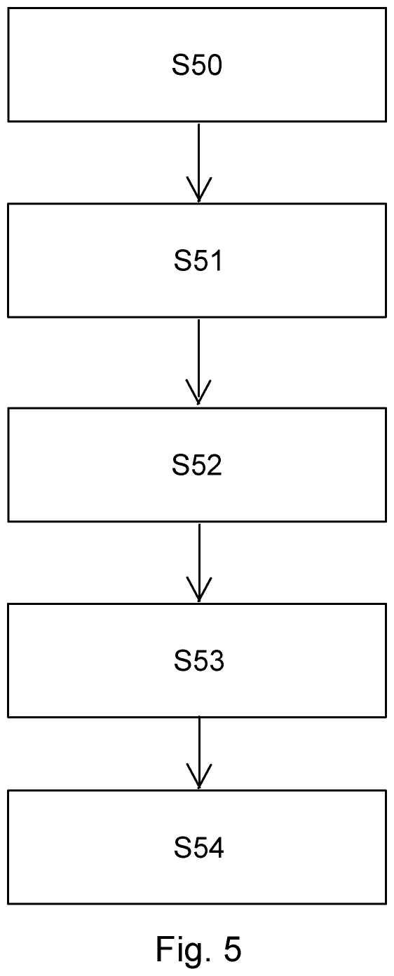

FIG. 5 shows a flowchart for illustrating a method for optical inspection of an object.

FIG. 1 schematically illustrates a device for classifying images and, if necessary, for optical inspection of an object according to an embodiment. The device 100 for classifying images and, if necessary, for the optical inspection of an object 10 has a chamber 106 or a test space 106 which is partially or completely shielded from external light. A rotatable platform 101 is provided in the chamber 106 or the test space 106, on which an object 10 to be inspected, for example a medical device such as a dialysis machine, is arranged for inspection. Alternatively, instead of a rotatable platform, an image capture device 102 can also be moved or rotated around the object 10. Furthermore, the image capture device 102, such as one or more single image cameras, for example four area cameras, or a video camera, which is configured to capture images of the object 10 and, in one embodiment, high-resolution images, for example with a size of 5496×3672 pixels, is provided in the chamber 106 or the test room 106.

In order to ensure constant and uniform illumination of the object 10 to be inspected, a lighting device 108 is also provided within the chamber 106 or the test space 106, which is configured to illuminate the object 10, and comprises an LED panel or several LED panels, for example. A drive device 107 for rotating the rotatable platform 101 and the image capture device 102 are connected to a control device 103 which is configured to control the inspection process by controlling the drive device 107 to rotate the rotatable platform 101 and by controlling the image capture device 102 to capture a series of images of the object 10 arranged on the platform 101 during the rotation of the platform 101. This configuration makes it possible to capture a plurality of images of the object to be inspected 10 from different perspectives by means of the image capture device 102 during the inspection process, and thus preferably to capture images of the entire exposed surface of the object 10 so that the entire exposed surface can be subjected to optical inspection for optical defects.

The control device 103 is also connected to a memory device 104 and a display device 105. The images captured by the image capture device 102 or the corresponding image data can be stored in the memory device 104. Furthermore, a program for classifying the images of the object 10 captured by the image capture device 102 is stored in the memory device 104, which program can be executed by the control device 103. In this context, the control device 103 and/or the memory device 104 can be arranged locally or remotely or may be designed in a distributed manner. A cloud-based architecture can thus be used.

In one embodiment, the program is configured to classify the images captured by the image capture device 102 as good images GB or bad images SB. For this purpose, the program has a software component designed as an artificial neural net(work).

The artificial neural network is or has been trained by supervised learning using training data including a plurality of good images GB and a plurality of bad images SB. The plurality of good images GB is formed by images of surfaces of an object 10 actually captured at different angles, which does not have any optical defects such as dents, scratches or spots that may have been insufficiently removed during the final cleaning and/or which is correctly labeled according to a specification and/or which is configured according to customer requirements. Here, a respective bad image SB of at least a subset of the plurality of bad images SB of the training data corresponds to a respective good image GB of at least a subset of the plurality of good images GB of the training data, into which at least one image error 11 has been artificially inserted. The at least one image error 11 is preferably selected such that it corresponds to or is at least similar to an image error or optical error that is actually to be expected, which occurs as a result of an optical defect of the object 10 in the image of the object 10.

In particular, the artificial neural network is or has been trained using respective pairs which are formed from a respective good image GB from the subset of the plurality of good images GB and a respective bad image SB from the subset of bad images SB, wherein a respective bad image SB corresponds to the good image GB belonging to the same pair, into which the at least one image error 11 is inserted. The at least one image error 11 can be generated, for example, by randomized pixel errors, lines of pixel errors or area errors, and/or by distorting, blurring or deforming at least one image portion of the good image GB and/or the use of affine image transformations, by augmented spots, circular, elliptical or rectangular shapes, which are preferably at least partially colored or filled in gray levels, from good images GB or from the corresponding image data. In this way, any number of bad images SB can be generated, whereby a plurality of optical defects can be simulated.

According to one embodiment, the artificial neural network is or has been trained by a respective adaptation of parameters of the artificial neural network after a respective input of the image data of a respective pair of a respective good image GB and a respective bad image SB. One advantage of this approach is that it enables the artificial neural network to distinguish the typical errors of a bad image SB from typical features of a good image GB, which is hardly possible if another approach is used to input training data.

The artificial neural network can be designed, for example, as a shallow convolutional neural network, which has an input layer, an output layer and several hidden layers provided in between, preferably a total of at least three, preferably six hidden layers, and two hidden classification layers for preprocessing the output.

Here, the training algorithm that is used to train the artificial neural network, and in particular the loss function used, is adapted to the particular choice of training data, namely the pairs of good images GB of the subset of the plurality of good images GB and bad images SB of the subset of the plurality of bad images SB.

Based on the relative similarity of the used good images GB of the subset of the plurality of good images GB and bad images SB of the subset of the plurality of bad images SB, very large or small gradients can lead to numerical instabilities in the gradient method, to aborts of the optimization process or to the determination of local minima, so that finding a suitable parameter set for the model can be difficult. According to the invention, this problem is solved by a combination of regularization in all network layers and the loss function, a final, normalizing softmax layer and a modern self-adaptive optimization method, for example a “rectifiedadam” method.

After the input layer, for example, six convolutional layers can follow as filter layers, wherein a rectifying activation function (ReLU) is used as the activation function of these layers. The convolutional layers reduce in their overall filter depth, wherein it can be started at a filter depth of 50 and the following depths are, for example, 40, 30, 20, 20, 10. As a regularization function, for example, the L2 norm can be used as a penalty term on the activation signals. After each convolutional layer there is processing, a pooling, for example by a MaxPooling layer with a 2×2 kernel. Before the subsequent dense layers, for example two dense layers, the data is transformed further via a flattening. The subsequent dense layers can be activated by the sigmoid function. For the output layer itself, the softmax activation function is used. The loss function is mapped by a so-called categorical cross entropy, in order to finally make the assignment to a good or bad image via the probability distribution.

Furthermore, the classification of the training data is preferably carried out using error feedback, in which the tracked neuron activity, from which the external (human) teacher can conclude the cause of the “bad image” classification made by the artificial neural network, can be visualized in the corresponding image on the display device 105.

By using the above-described artificial neural network designed as a flat convolutional neural network, and by training the artificial neural network in the manner described above, images with high resolution can be used without having to divide them into small sections. An order of magnitude is, for example, 3500×2500×3. Due to the small batch size of 2 (a pair of a good image GB and an associated bad image SB) and a shallow convolutional neural network architecture with preferably a total of at least three, preferably six hidden layers, the important resource of a video memory of the control device 103, which in the case of large network architectures and large batch sizes is often the bottleneck in terms of hardware when training neural networks, can be accessed very gently. The small number of hidden layers is sufficient to detect small, local optical errors, which enables pixel-precise processing of high-resolution image material with cheap resources and in a few seconds.

Referring to FIGS. 2 and 3, the advantages resulting from the training of the artificial neural network using respective pairs, which are formed from a respective good image GB and a respective bad image SB, wherein a respective bad image SB corresponds to the good image GB belonging to the same pair, into which the at least one image error 11 is inserted, and the respective adaptation of the parameters of the artificial neural network after a respective input of the image data of a respective pair, are explained.

FIG. 2A shows a good image GB actually captured by the image capture device 102 of an object 10 or a surface of the object 10 and FIG. 2B shows an actually captured bad image SB2 of another object 10 or the surface of the other object 10, which comprises a minimal actual optical defect 12, which is caused, for example, by a dent, a scratch or a spot, wherein the good image GB and the bad image SB2 were captured with the object 10 and the other object 10 being positioned slightly differently. FIG. 2C schematically shows an image DB2 which was generated by forming the difference between the intensities of the good image GB and the bad image SB2. Here, the depiction of the object 10 in dashed form illustrates that at least parts of the features of the object 10, possibly with a changed color, can be gathered from the difference image DB2. In particular, the image features of the minimal actual optical defect 12 contained in the bad image SB2 are almost completely lost in the difference image DB2 when the feature extraction is weighted by the artificial neural network, since there are too many differences between the two different image captures. Accordingly, in such a case, the features relevant to an optical error cannot be significantly trained and weighted.

FIG. 3A shows a good image GB actually captured by the image capture device 102 of an object 10, which has no optical defect, and FIG. 3B shows a bad image SB generated based on the good image GB, which was generated by inserting a minimal image error 11 into the good image GB. FIG. 3C shows an image which was generated by forming the difference between the intensities of the good image GB and the bad image SB. As can be seen from FIG. 3C, the image error 11 can be clearly seen in the image DB generated by forming the difference, so that the features relevant to an optical error can be significantly trained and weighted hereby.

Referring again to FIG. 1, after the capturing of image data of an image by means of the image capture device 102, the control device 103 is configured to classify the captured image as a good image or a bad image using the program for classifying the images captured by the image capture device 102 stored in the memory device 104, and to output the result of the classification on the display device 105.

According to one embodiment, a program for optical inspection of an object is also stored in the memory device 104, which program uses the program for classifying the images of the object 10 captured by the image capture device 102. The control device 103 is configured, by means of the program for inspection of the object stored in the memory device 104, to cause the image capture device 102 to capture image data of at least one image of the object 10, to classify the at least one image of the object 10 using the program for classifying the images captured by the image capture device 102 as a good image or a bad image, to determine that the object 10 is free of defects if the at least one image of the object 10 is classified as a good image, or to determine that the object is faulty if the at least one image of the object 10 is classified as a bad image.

The control device 103 is further configured, by means of the program for optical inspection of an object stored in the memory device 104, to cause the display device 105 to output information about the fact that the object 10 is free of defects if it is determined that the object 10 is free of defects, or to output information about the fact that the object is faulty when it is determined that the object is faulty.

Furthermore, the control device 103 is configured, by means of the program for optical inspection of an object stored in the memory device 104, to cause the display device 105 to display the at least one image of the object 10 and a mask that is generated based on an output of the artificial neural network, wherein the mask is superimposed on the at least one image of the object and indicates a defect of the object 10 output by the artificial neural network and its position.

FIG. 4 shows a flow diagram to illustrate a method according to an embodiment for classifying images according to good images and bad images.

In step S40, image data of an image are captured, wherein the image data can be captured, for example, by means of the image capture device 102, and can be image data of an image of the object 10.

In step S41, the image is classified as a good image GB or a bad image SB2, wherein the classification is made using an artificial neural network described above, which is trained by supervised learning using training data from a plurality of good images GB and a plurality of bad images SB, and each bad image SB of at least a subset of the plurality of bad images SB of the training data corresponds to a respective good image GB of at least a subset of the plurality of good images GB of the training data, into which at least one image error 11 is inserted.

Here, the artificial neural network can be trained using respective pairs of a respective good image GB from the subset of the plurality of good images GB and a respective bad image SB from the subset of the plurality of bad images SB, wherein a respective bad image SB corresponds to the good image GB belonging to the same pair, into which the at least one image error 11 is inserted.

In this context, the artificial neural network can be trained by a respective adaptation of parameters of the artificial neural network after a respective input of the image data of a respective pair of a respective good image GB and a respective bad image SB.

The at least one image error 11 can be a randomized pixel error, a line of pixel errors or an area error, and/or be generated by distorting, blurring or deforming an image portion of the good image GB, by an affine image transformation of the good image GB, by augmented spots, circular, elliptical or rectangular shapes, which are preferably at least partially colored or filled in gray levels.

The artificial neural network can be designed as a convolutional neural network which has an input layer, an output layer and several hidden layers arranged in between, wherein during the training of the artificial neural network a combination of regularization in all hidden layers with a loss function is taking place.

In this context, the artificial neural network can be configured to convert an output of the last layer of the artificial neural network into a probability distribution by a softmax function, wherein the classification is made based on the probability distribution.

Furthermore, here, the artificial neural network can be trained using a self-adaptive optimization method, preferably a rectified adam method.

FIG. 5 shows a flowchart to illustrate a method according to an embodiment for optical inspection of an object.

In step S50, image data of at least one image of the object 10 are captured, for example using the image capture device 102.

In step S51, the at least one image of the object 10 is then classified as a good image or as a bad image using the method described with reference to FIG. 4, wherein capturing image data of an image includes the capturing of image data of the at least one image of the object 10.

In step S52 it is determined that the object 10 is free of defects if the at least one image of the object 10 is classified as a good image in step S51, or it is determined that the object 10 is faulty if the at least one image of the object 10 is classified as a bad picture in step S51.

In step S53, for example by means of the display device 105, information about the fact that the object 10 is free of defects is output if it is determined in step S52 that the object 10 is free of defects, or information about the fact that the object 10 is faulty is output if it is determined in step S52 that the object 10 is faulty.

In step S54, if it is determined in step S52 that the object 10 is faulty, the at least one image of the object 10 and a mask which is generated based on an output of the artificial neural network are displayed by means of the display device 105, wherein the mask superimposes the at least one image of the object 10 and indicates a defect of the object 10 output by the artificial neural network and its position.

The capturing of image data of at least one image of the object 10 can include the capturing of image data of a plurality of images of the object 10 at a plurality of different angles relative to the object 10, wherein it is determined in step S52 that the object 10 is free of defects if each of the plurality of images of the object 10 is classified as a good image in step S51, or it is determined in step S52 that the object 10 is faulty if at least one of the plurality of images of the object 10 is classified as a bad image in step S51.

In this context, in one embodiment, the capturing of image data of a plurality of images of the object 10 at a plurality of different angles relative to the object 10 can include arranging the object 10 on the rotatable platform 101, controlling the drive device 107 of the rotatable platform 101, by means of the control device 103, to rotate the rotatable platform 101, and capturing, by means of the image capture device 102, the image data of the plurality of images of the object 10 at the plurality of different angles relative to the object 10, while the rotatable platform 101 is rotated by the drive device 107.

In another embodiment, the capturing of image data of a plurality of images of the object 10 at a plurality of different angles relative to the object 10 can include arranging the object 10 on a platform, controlling a drive device of an image capture device, to move the image capture device around the object 10, and capturing, by means of the image capture device, the image data of the plurality of images of the object 10 at the plurality of different angles relative to the object, while the image capture device is moved around the object 10 by the drive device.

Here, the artificial neural network can be trained in particular using training data from good images GB and bad images SB, wherein the good images GB each are images of at least a portion of a medical device, preferably a dialysis machine.

Furthermore, here, the at least one image error 11 can correspond to an optical defect of a surface of the object 10, preferably a scratch or a dent in the surface of the object 10 or a spot on the surface of the object 10.

1. A method for classifying images, in which the images are classified according to good images and bad images, comprising the steps:
capturing image data of an image, and
classifying the image as a good image or a bad image,
wherein the classification is made using an artificial neural network trained by supervised learning using training data from a plurality of good images and a plurality of bad images,
wherein each bad image of at least a subset of the plurality of bad images of the training data corresponds to a respective good image of at least a subset of the plurality of good images of the training data, into which at least one image error is inserted, and
wherein the artificial neural network is trained using respective pairs of a respective good image from the subset of the plurality of good images and a respective bad image from the subset of the plurality of bad images, wherein a respective bad image corresponds to the good image belonging to the same pair, into which the at least one image error is inserted.

2. The method according to claim 1, wherein the artificial neural network is trained by a respective adaptation of parameters of the artificial neural network after a respective input of the image data of a respective pair of a respective good image and a respective bad image.

3. The method according to claim 1, in which the at least one image error is a randomized pixel error, a line of pixel errors or an area error, and/or generated by distorting, blurring or deforming an image portion of the good image, by an affine image transformation of the good image, by augmented spots, circular, elliptical or rectangular shapes.

4. The method according to claim 1, in which the artificial neural network is designed as a convolutional neural network which has an input layer, an output layer and several hidden layers arranged in between, wherein during the training of the artificial neural network a combination of regularization in all hidden layers with a loss function is taking place.

5. The method according to claim 4, in which an output of the last layer of the artificial neural network is converted into a probability distribution by a softmax function, and the classification is made on the basis of the probability distribution.

6. The method according to claim 5, in which the artificial neural network is trained using a self-adaptive optimization method.

7. A method for optical inspection of an object, comprising the steps:
capturing image data of at least one image of the object,
classifying the at least one image of the object as a good image or as a bad image using a method for classifying images according to claim 1, wherein the capturing of image data of an image includes the capturing of image data of the at least one image of the object,
determining that the object is free of defects if the at least one image of the object is classified as a good image, or
determining that the object is faulty if the at least one image of the object is classified as a bad image.

8. The method for optical inspection of an object according to claim 7, further comprising the steps:
outputting, by means of an output device, information about the fact that the object is free of defects if it is determined that the object is free of defects, or
outputting, by means of the output device, information about the fact that the object is faulty if it is determined that the object is faulty.

9. The method for optical inspection of an object according to claim 8, further comprising the step:
displaying, if it is determined that the object is faulty, by means of an output device designed as a display device, the at least one image of the object and a mask which is generated based on an output of the artificial neural network, wherein the mask is superimposed on the at least one image of the object and indicates a defect of the object which is output by the artificial neural network, and its position.

10. The method for optical inspection of an object according to claim 7, in which the capturing of image data of at least one image of the object comprises capturing image data of a plurality of images of the object at a plurality of different angles relative to the object, wherein
it is determined that the object is free of defects if each of the plurality of images of the object is classified as a good image, or
it is determined that the object is faulty if at least one of the plurality of images of the object is classified as a bad image.

11. The method for optical inspection of an object according to claim 10, wherein the capturing of image data of a plurality of images of the object a plurality of different angles relative to the object comprises:
arranging the object on a rotatable platform,
controlling a drive device of the rotatable platform in order to rotate the rotatable platform, and
capturing, by means of an image capture device, the image data of the plurality of images of the object at the plurality of different angles relative to the object while the rotatable platform is rotated by the drive device.

12. The method for optical inspection of an object according to claim 10, wherein the capturing of image data of a plurality of images of the object at a plurality of different angles relative to the object comprises:
arranging the object on a platform,
controlling a drive device of an image capture device in order to move the image capture device around the object, and
capturing, by means of the image capture device, the image data of the plurality of images of the object at the plurality of different angles relative to the object, while the image capture device is moved around the object by the drive device.

13. The method for optical inspection of an object according to claim 7, in which the artificial neural network is trained using training data from a plurality of good images and a plurality of bad images, the good images each being images of at least one portion of a medical device.

14. The method for optical inspection of an object according to claim 7, in which the at least one image error corresponds to an optical defect of a surface of the object.

15. The method according to claim 1, in which the at least one image error is a randomized pixel error, a line of pixel errors or an area error, and/or generated by distorting, blurring or deforming an image portion of the good image, by an affine image transformation of the good image, by augmented spots, circular, elliptical or rectangular shapes, which are at least partially colored or filled in gray levels.

16. The method according to claim 5, in which the artificial neural network is trained using a self-adaptive optimization method that is a rectified adam method.

17. The method for optical inspection of an object according to claim 13, wherein the medical device is a dialysis machine.

18. The method for optical inspection of an object according to claim 7, in which the at least one image error corresponds to an optical defect of a surface of the object, that is a scratch or a dent in the surface of the object or a spot on the surface of the object.
